(19) United States
(12) Patent Application Publication
(10) Pub. No.: US 2026/0333474 A1
(43) Pub. Date: Oct. 22, 2026

(54) X2 LINK SETUP MANAGEMENT IN A NETWORK

(71) Applicant: Rakuten Symphony, Inc., Tokyo (JP)

(72) Inventors: Balaji Prasath KUMARARAJ, Dubai (AE); Senthil Kumar KURUPPASAMY, Düsseldorf (DE)

(73) Assignee: Rakuten Symphony, Inc., Tokyo (JP)

(21) Appl. No.: 18/831,833

(22) PCT Filed: Dec. 30, 2024
(86) PCT No.: PCT/US2024/062231

§ 371 Date: Sep. 26, 2025

(51) Int. Cl. H04W 76/14; H04B 7/04; H04W 92/20

(52) U.S. Cl. CPC H04W 76/14; H04B 7/04013; H04W 92/20

(57) ABSTRACT

Provided are system, method, and device for automatically manage X2 link setup in a network. According to example embodiments, the system may comprise a RAN Intelligence Controller (RIC) that may be configured to: obtain, from a first base station, Transfer Network Layer (TNL) information of the first base station; store the TNL information of the first base station in a database; receive, from a second base station, a request for the TNL information of the first base station; retrieve the TNL information specified in the request from the database; and transmit the retrieved TNL information to the second base station.

### FIELD

The present disclosure relates to the management of setting up an X2 link in a telecommunications network.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

In this regard, X2 interface refers to a logical connection between two base stations within the RAN, which allows the two base stations to establish a link (X2 link) to communicate and exchange information for resource management, handover procedures, load balancing, interference coordination, and the like.

### SUMMARY

Example embodiments of the present disclosure automatically manage setting up of X2 link. As such, example embodiments of the present disclosure allow for X2 link to be established between two base stations with reduced signaling and network elements, thereby reducing overall time requirements, reducing risk of errors and improving overall performance.

According to example embodiments, a system is provided. The system may comprise a RAN Intelligence Controller (RIC) that may be configured to: obtain, from a first base station, Transfer Network Layer (TNL) information of the first base station; store the TNL information of the first base station in a database; receive, from a second base station, a request for the TNL information of the first base station; retrieve the TNL information specified in the request from the database; and transmit the retrieved TNL information to the second base station.

According to example embodiments, a method is provided. The method may include: obtaining, by a RAN Intelligence Controller (RIC) from a first base station, Transfer Network Layer (TNL) information of the first base station; storing, by the RIC, the TNL information of the first base station in a database; receiving, by the RIC from a second base station, a request for the TNL information of the first base station; retrieving, by the RIC, the TNL information specified in the request from the database; and transmitting, by the RIC, the retrieved TNL information to the second base station.

According to example embodiments, a non-transitory computer-readable recording medium is provided. The non-transitory computer-readable recording medium may have recorded thereon instructions executable by a system that may include a RAN Intelligence Controller (RIC) to cause the RIC to perform a method including: obtaining, from a first base station, Transfer Network Layer (TNL) information of the first base station; storing the TNL information of the first base station in a database; receiving, from a second base station, a request for the TNL information of the first base station; retrieving the TNL information specified in the request from the database; and transmitting the retrieved TNL information to the second base station.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example call flow for setting up an X2 link in the related art;

FIG. 2 illustrates an example system architecture, according to one or more example embodiments;

FIG. 3 illustrates a flow diagram of an example method for managing X2 link setup, according to one or more example embodiments;

FIG. 4 illustrates a flow diagram of an example method for obtaining TNL information, according to one or more example embodiments;

FIG. 5 illustrates a flow sequence of an example use case for managing X2 link setup, according to one or more example embodiments;

FIG. 6 illustrates a flow sequence of an example use case for obtaining TNL information, according to one or more example embodiments;

FIG. 7 illustrates a diagram of example components of a device for implementing one or more example embodiments; and

FIG. 8 illustrates a diagram of an example of implementation environment in which systems and/or method, described herein, may be implemented.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

The foregoing disclosure provides illustration and description but is not intended to be exhaustive or to limit the implementations to the precise form disclosed. Modifications and variations are possible in light of the above disclosure or may be acquired from practice of the implementations.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “X2”, “eNB”, “gNB”, “MME”, “RIC”, and the like, as well as the associated features and operations, are to be interpreted as consistent with those specified in one or more technical specifications.

The one or more technical specifications may include, for example, 3GPP specification 36.423, 3GPP specification 38.424, and the like.

Further, although some embodiments of the present disclosure may be described herein with reference specific components of 4G/5G system, it can be understood that the scope of the present disclosure should not be limited thereto. Specifically, example embodiments of the present disclosure may also apply to any suitable network elements in any suitable telecommunications system, such as a 4G LTE system, a 6G system, and the like, without departing from the scope of the present disclosure.

As described above, X2 interface allows two base stations to establish a link (X2 link) to communicate and exchange information for resource management, handover procedures, load balancing, interference coordination, and the like.

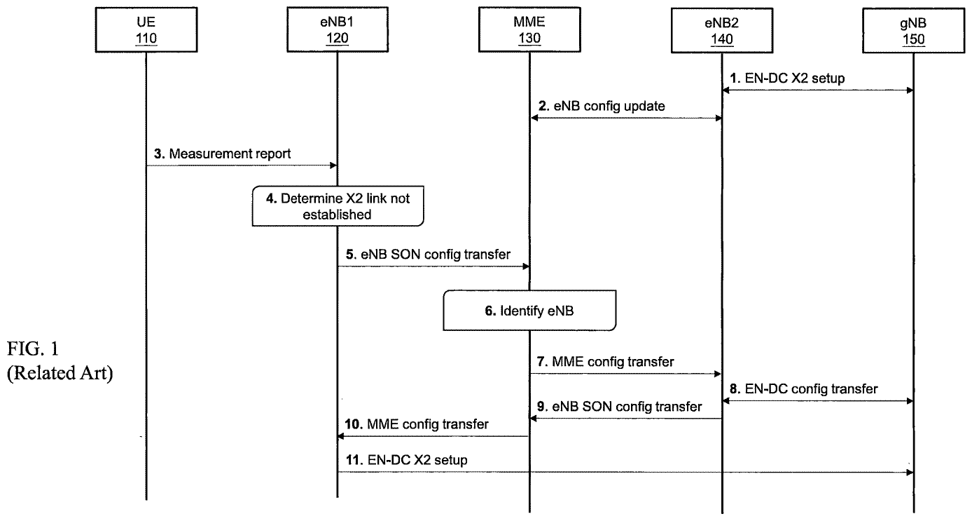

FIG. 1 illustrates an example call flow for setting up an X2 link in the related art. As shown in FIG. 1, the process for setting up an X2 link in the related art may involve a user equipment (UE) 110, an eNodeB1 (eNB1) 120, a Mobility Management Entity (MME) 130, an eNodeB2 (eNB2) 140, and a gNodeB (gNB) 150.

At step 1, the gNB 150 performs an Evolved Non-standalone Dual Connectivity (EN-DC) X2 link setup with eNB2 140. Once the EN-DC X2 link is setup, at step 2, the eNB2 140 transmits an eNB configuration update message to the MME 130, in order to update the MME 130 with a list of connected gNB. Here, the list of connected gNB includes the gNB150 which the eNB2 140 established the EN-DC X2 link during step 1.

At a later time, at step 3, the UE 110 transmits a measurement report to the eNB1 120. The measurement report includes a New Radio Cell Global Identity (NR CGI), which specifies a unique identifier of the gNB 150 in the network.

At step 4, the eNB1 120 determines if it has established an X2 link with the gNB 150 (i.e., the gNB specified in the NR CGI), and identifies that it does not have X2 link established with the gNB 150. Subsequently, at step 5, the eNB1 120 transmits an eNB Self-Organizing Network (SON) configuration transfer to the MME 130 in order to query for details regarding Transport Network Layer (TNL) of the gNB 150. The TNL information may be used by the eNB1 120 to establish an X2 link with the gNB 150.

In response, at step 6, the MME 130 looks up its database to identify which eNB reported gNB 150 as part of its list of connected gNB, and identifies that eNB2 140 has gNB 150 as part of its list of connected gNB (i.e., during step 2). Subsequently, at step 7, the MME 130 transmits an MME configuration transfer to the eNB2 140 in order to query for details regarding TNL of the gNB 150.

In response, at step 8, the eNB2 140 transmits an EN-DC configuration transfer to the gNB 150 in order to obtain details regarding TNL of the gNB 150, and then, at step 9, transmits an eNB SON configuration transfer to the MME 130 in order to provide the details regarding TNL of the gNB 150 to the MME 130.

At step 10, the MME transmits an MME configuration transfer to the eNB1 120 in order to provide the details regarding TNL of the gNB 150 to the eNB1 120, where, at step 11, the eNB1 120 then performs an EN-DC X2 link setup with the gNB 150 based on the obtained TNL of the gNB 150.

Here, as described above, the process for setting up an X2 link between two base stations (i.e., eNB1 120 and gNB 150) in the related art involves many signaling between many network elements. Such involvement of a large number of signaling and network elements pose a high risk of error, as there are many points of failures where any issue occurring between any of the network elements with any of the signals may cause an error to the entire X2 link setup process resulting in delays and reduced performance.

Accordingly, system, methods, devices, and the like, provided in the example embodiments of the present disclosure automatically manage X2 link setup in the network.

According to example embodiments, a RAN Intelligence Controller (RIC) may first obtain a Transfer Network Layer (TNL) information of a first base station from the first base station, and store the TNL information in a database. Then, at a later time, the RIC may receive a request for the TNL information of the first base station from a second base station. In response, the RIC may retrieve the TNL information specified in the request from the database, and accordingly transmit the retrieved TNL information to the second base station.

Ultimately, example embodiments of the present disclosure automatically manage X2 link setup, which allow for X2 link to be established between two base stations with reduced signaling and network elements, thereby reducing overall time requirements, reducing risk of errors and improving overall performance.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system of the present disclosure, according to one or more example embodiments, are provided in the following.

### Example System Architecture

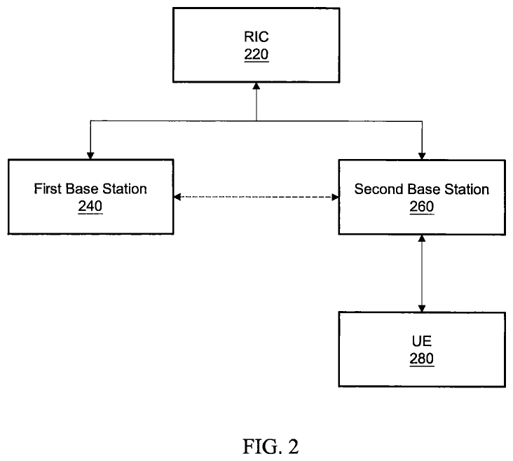

FIG. 2 illustrates an example system architecture, according to one or more example embodiments. As illustrated in FIG. 2, the system architecture may include at least one RAN Intelligence Controller (RIC) 220, at least two base stations (first base station 240 and second base station 260), and at least one user equipment (UE) 280.

It is contemplated that the system architecture may include more/fewer components than illustrated, and/or may be configured in a different manner, without departing from the scope of the present disclosure. For instance, in some implementations, the system architecture may further include a third base station and the like.

The RIC 220 may include an apparatus, a system, a platform, a module, or the like, which may be configured to perform one or more operations or actions for managing X2 link setup. The RIC 220 may be a software-defined component that implements modular applications to facilitate the multivendor operability, as well as to automate and optimize RAN operations. In other words, the RIC 220 may control and optimize RAN functions in the system. According to example embodiments, the RIC 220 may be divided into two types, i.e., a non-real-time RIC (Non-RT RIC) and a near-real-time RIC (Near-RT RIC).

The Non-RT RIC may refer to a logical function within an SMO framework of an O-RAN architecture that drives the content carried across an A1 interface to enable non-real-time control and optimization of RAN elements and resources. The A1 interface may refer to a logical interface between the Non-RT RIC and the Near-RT RIC, which enables the Non-RT RIC to provide policy-based guidance (objective, resource) to the Near-RT RIC and enables the Near-RT RIC to provide one or more feedbacks to the Non-RT RIC to monitor the status of one or more policies.

In some example, implementations, the Non-RT RIC may be the control point of a non-real-time control loop and may operate on a timescale greater than 1 second within the SMO framework. The functionalities of the Non-RT RIC may include, for example, providing policy-based guidance and enrichment across the A1 interface, performing data analytics, Artificial Intelligence/Machine Learning (AI/ML) models training and inference for RAN optimization, and/or recommending configuration management actions. As further described below, the Non-RT RIC may access or communicate with other SMO framework functionalities or components via A1 interface, O1 interface, O2 interface, and one or more interfaces associated with one or more open fronthaul planes.

The Near-RT RIC may refer to a logical function that enables near-real-time control and optimization of RAN elements and resources. For instance, the Near-RT RIC may provide the near-real-time control and optimization via fine-grained (e.g., UE basis, Cell basis) data collection and actions over an E2 interface. In some example, implementations, the Near-RT RIC may operate on a timescale between 10 milliseconds and 1 second and may be coupled with O-RAN network elements, such as the O-CU, O-eNB, O-DU, and the like via the E2 interface. The Near-RT RIC may use the E2 interface to control the underlying RAN elements (E2 nodes/network functions (NFs)) over a near-real-time control loop.

According to example embodiments, the Near-RT RIC may monitor, suspend/stop, override, and control the E2 nodes (e.g., the O-CU, O-eNB, O-DU, etc.) via one or more policies (e.g., A1 policies). For example, the Near-RT RIC may receive the one or more A1 policies from the Non-RT RIC and then configure or set one or more policy parameters associated with the one or more A1 policies on activated functions of the E2 nodes. Further, the Near-RT RIC may implement functions such as quality of service (QoS) optimization, mobility optimization, slicing optimization, interference mitigation, load balancing, security, and the like.

In addition, the management of X2 link setup described herein may refer to the process of exchanging information (e.g., TNL information, E2 link setup, subscription information, etc.) which may be used to perform the actual X2 link set up.

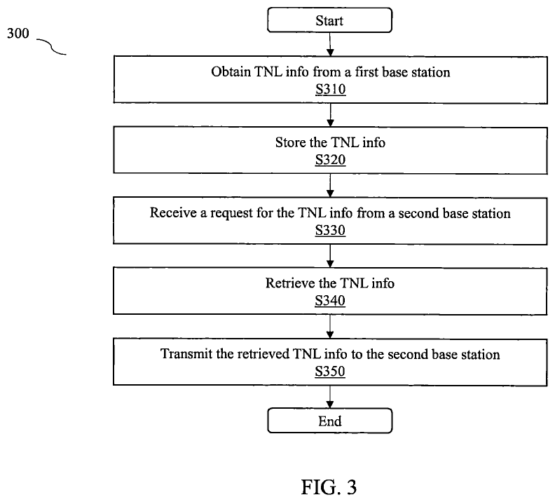

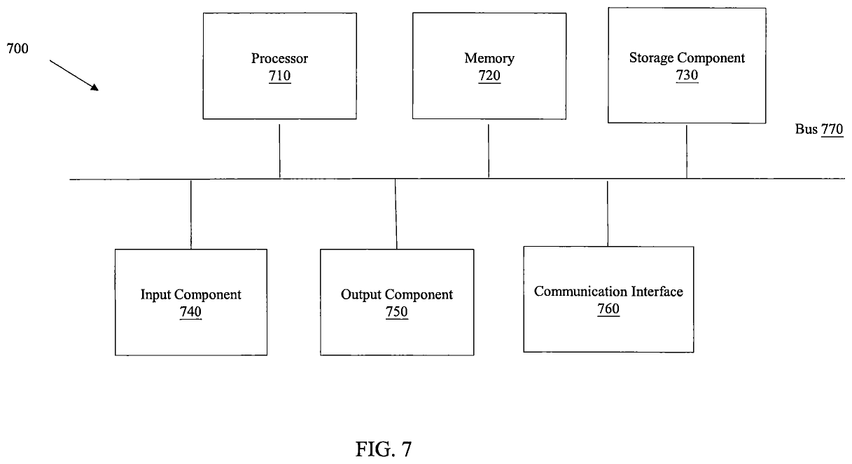

Example operations performable by the RIC 220 for managing X2 link setup are described below with reference to FIG. 3 to FIG. 6. Further, several example components which may be included in the RIC 220, according to one or more example embodiments, are described below with reference to FIG. 7.

The first base station 240 and the second base station 260 may include base stations in a network, such as centralized unit (CU), distributed unit (DU), radio unit (RU), eNodeB (eNB), gNodeB (gNB), and the like. The first base station 240 and the second base station 260 may be communicatively coupled to the RIC 220 via the E2 interface. Further, the first base station 240 and the second base station 260 may each include an X2 interface, where, through the X2 link setup process described herein, the first base station 240 and the second base station 260 may establish an X2 link with each other and be communicatively coupled via the X2 link for resource management, handover procedures, load balancing, interference coordination, and the like as shown by the dotted line. Furthermore, the second base station 260 may be communicatively coupled to the UE 280.

The UE 280 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), a SIM-based device, or a similar device.

It is understood that, while the above descriptions are provided in relation to X2 link setup, the present disclosure is not limited thereto and can include setup/establishment of any kind of communication links between any kind of base stations. For example, the present disclosure encompasses LTE eNB-eNB X2 link setup, NR gNB-gNB Xn link setup, and the like, as well as other kinds of link setup.

### Example Operations for Managing X2 Link Setup in the Present Disclosure

In the following, several example operations are performable by the system of one or more example embodiments of the present disclosure are described with reference to FIG. 3 to FIG. 6.

FIG. 3 illustrates a flow diagram of an example method 300 for managing X2 link setup, according to one or more example embodiments. One or more operations in method 300 may be performed by the system of one or more example embodiments of the present disclosure. The system may be configured to manage X2 link setup. According to example embodiments, the system may include a RAN Intelligence Controller (RIC), which may be configured to perform one or more operations in method 300.

As illustrated in FIG. 3, at operation S310, the system may be configured to obtain Transfer Network Layer (TNL) information of a first base station. The TNL information may be obtained from the first base station and may include information associated with transfer network layer of the first base station. According to example embodiments, information associated with transfer network layer of the first base station may include information associated with routing of data to and from the first base station, such as IP address of the first base station, network layer protocols associated with the first base station, and the like. According to example embodiments, information associated with transfer network layer of the first base station may include information utilized in order to establish (setup) an X2 link between base stations.

According to example embodiments, the system may be configured to obtain the TNL information of the first base station by transmitting a request to receive the TNL information of the first base station to the first base station, and receiving the TNL information of the first base station from the first base station. In such case, the request to receive the TNL information of the first base station may be transmitted to the first base station in response to completion of an E2 link setup with the first base station. According to example embodiments, the system may be configured to obtain the TNL information of the first base station by establishing a subscription with the first base station to receive updated TNL information of the first base station, and receiving the updated TNL information of the first base station from the first base station.

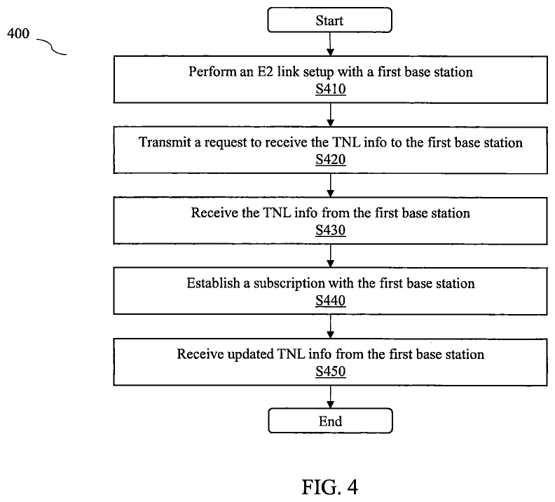

Examples of operations for obtaining the TNL information are described below with reference to FIG. 4. The method then proceeds to operation S320.

At operation S320, the system may be configured to store the TNL information of the first base station. The TNL information of the first base station may be stored in a database comprised in the system. According to example embodiments, the TNL information of the first base station may be stored in a database comprised in the RIC. The method then proceeds to operation S330.

At operation S330, the system may be configured to receive a request for the TNL information of the first base station. The request for the TNL information of the first base station may be received from a second base station. According to example embodiments, the request for the TNL information of the first base station may include a RIC indication message received via a RIC report service, where the RIC indication message may include a New Radio Cell Global Identity (NR CGI) specifying an identifier of the first base station. The method then proceeds to operation S340.

At operation S340, the system may be configured to retrieve the TNL information specified in the request (i.e., the TNL information of the first base station) from the database. In particular, the system may be configured to identify that the identifier specified in the received request corresponds to the identifier of the first base station, and accordingly retrieve TNL information of the first base station. In other words, the system may be configured to search the database for TNL information of a base station corresponding to the identifier specified in the received request. The method then proceeds to operation S350.

At operation S350, the system may be configured to transmit the retrieved TNL information (i.e., TNL information specified in the request retrieved during operation S340) to the second base station. According to example embodiments, the retrieved TNL information of the first base station may be transmitted to the second base station via RIC Control Service Style 1 (Node Configuration and Control).

Accordingly, in response to receiving the TNL information of the first base station, the second base station may be configured to establish and setup an interface link with the first base station based on the received TNL information of the first base station. The interface link may be any interface link between a base station and a RIC. For example, in response to receiving the TNL information of the first base station, the second base station may be configured to establish and setup an X2 link with the first base station based on the received TNL information of the first base station.

Upon performing operation S350, the method 300 may be ended or be terminated. Alternatively, method 300 may return to operation S310, such that the at least one processor may be configured to repeatedly perform, for at least a predetermined amount of time, the obtaining the TNL information (at operation S310), the storing the TNL information (at operation S320), the receiving the request (at operation S330), the retrieving the TNL information (at operation S340), and the transmitting the retrieved TNL information (at operation S350).

For instance, the system may later receive a request for the TNL information of the first base station from a third base station, and accordingly perform the receiving the request (at operation S330), the retrieving the TNL information (at operation S340), and the transmitting the retrieved TNL information to the third base station (at operation S350). In another example, the system may later obtain TNL information from a third database and then receive a request for the TNL information of the third base station from the second base station. Accordingly, the system may perform the obtaining the TNL information of the third base station (at operation S310), the storing the TNL information (at operation S320), the receiving the request (at operation S330), the retrieving the TNL information (at operation S340), and the transmitting the retrieved TNL information (at operation S350).

Accordingly, the above processes allow for X2 link to be established between two base stations with reduced signaling and network elements, thereby reducing overall time requirements, reducing risk of errors and improving overall performance.

Further, the involvement of RIC allows the RIC to act as a single point of contact (SPOC) to facilitate setting up X2 link between base stations, without involving MME or other base stations to retrieve the TNL information.

Additionally, the above described operations in method 300 may be performed in combination the process for setting up X2 link in the related art (e.g., process described above in relation to FIG. 1). For example, the process for setting up X2 link in the related art described above in relation to FIG. 1 may be utilized if an error is detected during any one of the operations in method 300 as a back-up strategy. In another example, the process for setting up X2 link in the related art described above in relation to FIG. 1 may be utilized in parallel with the operations in method 300.

FIG. 4 illustrates a flow diagram of an example method 400 for obtaining TNL information, according to one or more example embodiments. One or more operations of method 400 may be part of operation S310 in method 300, and may be performed by the system of one or more example embodiments of the present disclosure.

As illustrated in FIG. 4, at operation S410, the system may be configured to perform an E2 link setup with a first base station. The E2 link setup may refer to a process to establish a communication via E2 interface between the system (e.g., RIC) and a base station (e.g., gNB).

In particular, the system may be configured to perform the E2 link setup with the first base station by: receiving a request to establish the E2 link from the first base station, and transmitting a response to the request to the first base station in order to establish the E2 link. The method then proceeds to operation S420.

At operation S420, the system may be configured to transmit a request to receive TNL information of the first base station to the first base station. The request may be transmitted to the first base station, in response to completion of the E2 link setup with the first base station. In other words, once the system completes the E2 link setup with the first base station, the system may transmit a request to receive TNL information of the first base station to the first base station. The method then proceeds to operation S430.

At operation S430, the system may be configured to receive the TNL information of the first base station from the first base station. Here, the TNL information of the first base station received during operation S420 may be an initial TNL information of the first base station received by the system at the time of completion of the E2 link setup. The method then proceeds to operation S440.

At operation S440, the system may be configured to establish a subscription with the first base station to receive updated TNL information of the first base station. In particular, after the TNL information of the first base station is transmitted to the system during operation S430 (i.e., initial TNL information of the first base station received by the system at the time of completion of the E2 link setup), the configuration of the first base station may later be updated and/or changed, such that its TNL information is updated. Accordingly, in order for the system to maintain the most up to date TNL information of the first base station, the system may be subscribed to the first base station, such that the first base station transmits any update to its TNL information to the system (i.e., updated TNL information of the first base station). The method then proceeds to operation S450.

At operation S450, the system may be configured to receive the updated TNL information of the first base station from the first base station. According to example embodiments, the updated TNL information of the first base station may be included in a RIC indication message received via a RIC report service. The RIC indication message may specify E2 node information change.

According to example embodiments, the system may be configured to store the updated TNL information of the first base station.

Here, it is understood that, once the TNL information of the first base station is transmitted to the system during operation S430 (i.e., initial TNL information of the first base station received by the system at the time of completion of the E2 link setup), the system may store such initial TNL information of the first base station in the similar manner as described above in relation to operation S320 in method 300.

In this regard, if the system receives the request for the TNL information from the second base station during operation S330 in method 300 before receiving the updated TNL information of the first base station during operation S450, then the system may be configured to retrieve the initial TNL information of the first base station (i.e., most recent version of the TNL information of the first base station currently stored in the database) and transmit such initial TNL information of the first base station during operations S340 and S350.

On the other hand, if the system receives the request for the TNL information from the second base station during operation S330 in method 300 after receiving the updated TNL information of the first base station during operation S450 (i.e., the updated TNL information of the first base station was received and stored at the database before receiving the request), then the system may be configured to retrieve the updated TNL information of the first base station (i.e., most recent version of the TNL information of the first base station currently stored in the database) and transmit such updated TNL information of the first base station during operations S340 and S350.

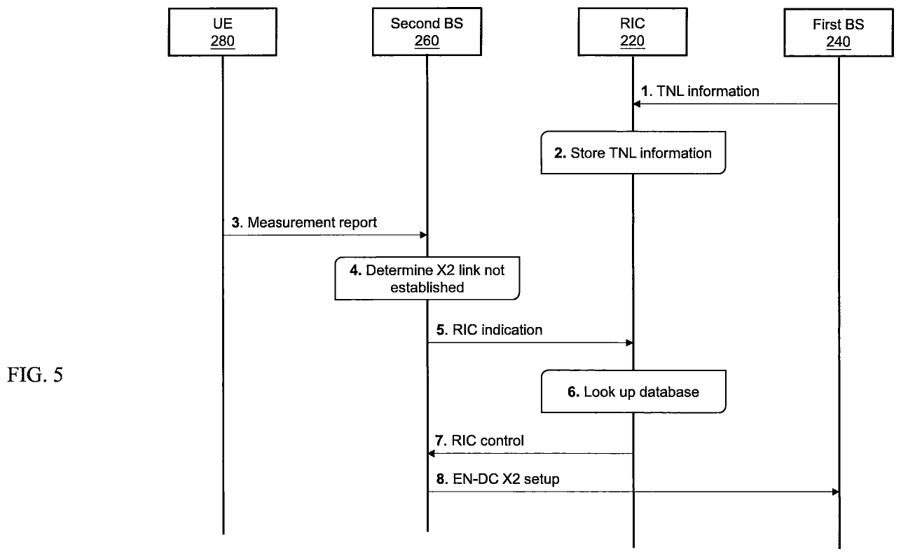

FIG. 5 illustrates a flow sequence of an example use case for managing X2 link setup, according to one or more example embodiments. As shown in FIG. 5, the flow sequence may involve a UE 280, second base station (BS) 260, RAN Intelligence Controller (RIC) 220, and first base station (BS) 240. The UE 280, second base station (BS) 260, RAN Intelligence Controller (RIC) 220, and first base station (BS) 240 may be similar to the UE 280, second base station 260, RAN Intelligence Controller (RIC) 220, and first base station 240 described above in relation to FIG. 2. Further, one or more operations in FIG. 5 may involve or may be part of one or more operations described above with reference to FIG. 3 and FIG. 4.

At step 1, the RIC 220 may obtain the TNL information of the first BS 240 from the first BS 240, in the similar manner as described above in relation to operation S310 in method 300. According to example embodiments, the RIC 220 may obtain the TNL information of the first BS 240 via an E2 interface.

At step 2, the RIC 220 may store the TNL information of the first BS 240, in the similar manner as described above in relation to operation S320 in method 300.

At step 3, the UE 280 may transmit a measurement report to the second BS 260. The measurement report may include a New Radio Cell Global Identity (NR CGI), which specifies a unique identifier of the first BS 240.

At step 4, the second BS 260 may determine if it has established an X2 link with the first BS 240 (i.e., the BS specified in the NR CGI), and identifies that it does not have X2 link established with the first BS 240. Subsequently, at step 5, the second BS 260 may transmit a RIC indication message via a RIC report service to the RIC 220, where the RIC indication message may include a request for the TNL information of the first BS 240, in the similar manner as described above in relation to operation S330 in method 300. According to example embodiments, the second BS 260 may transmit the RIC indication message via an E2 interface.

At step 6, the RIC 220 may look up its database and retrieve the TNL information specified in the request (i.e., TNL information of the first BS 240) from the database, in the similar manner as described above in relation to operation S340 in method 300.

At step 7, the RIC 220 may transmit the retrieved TNL information to the second BS 260, in the similar manner as described above in relation to operation S350 in method 300.

Subsequently, at step 8, the second BS 260 performs an EN-DC X2 link setup with the first BS 240 based on the obtained TNL information of the first BS 240.

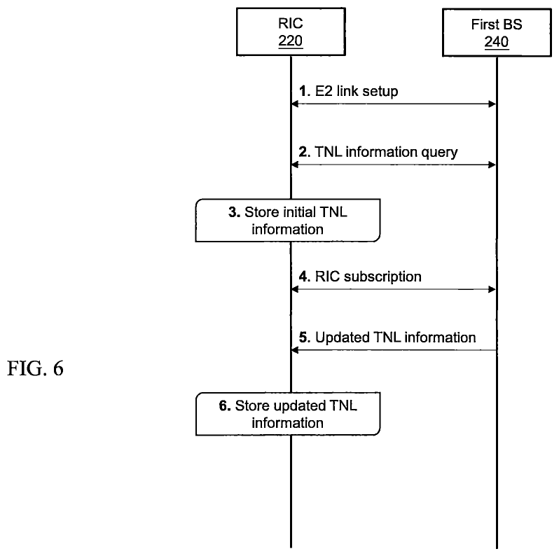

FIG. 6 illustrates a flow sequence of an example use case for obtaining TNL information, according to one or more example embodiments. As shown in FIG. 6, the flow sequence may involve a RAN Intelligence Controller (RIC) 220 and first base station (BS) 240. The RAN Intelligence Controller (RIC) 220 and first base station (BS) 240 may be similar to the RAN Intelligence Controller (RIC) 220 and first base station 240 described above in relation to FIG. 2. Further, one or more operations in FIG. 6 may involve or may be part of one or more operations described above with reference to FIG. 3 and FIG. 4.

At step 1, the first BS 240 may perform an E2 link setup with the RIC 220, in the similar manner as described above in relation to operation S410 in method 400.

At step 2, the RIC 220 may request for and receive TNL information of the first BS 240 (i.e., initial TNL information), in the similar manner as described above in relation to operations S420 and S430 in method 400. Subsequently, at step 3, the RIC 220 may store the TNL information of the first BS 240 (i.e., initial TNL information), in the similar manner as described above in relation to operation S320 in method 300.

At step 4, the RIC 220 may establish a subscription with the first BS 240 to receive updated TNL information of the first BS 240, in the similar manner as described above in relation to operation S440 in method 400.

Here, the first BS 240 may update its TNL information, and then transmit the updated TNL information to the RIC 220 at step 5.

Subsequently, at step 6, the RIC 220 may store the updated TNL information of the first BS 240 in the similar manner as described above in relation to operation S320 in method 300.

### Various Aspects of Embodiments

According to example embodiments, a mechanism for establishing an X2 link between base stations is provided, with reduced signaling and network elements involved, thereby reducing risk of errors and improving overall performance.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

One or more components of the system of the example embodiments (e.g., Non-RT RIC, Near-RT RIC, etc.), as well as the operations associated therewith (e.g., one or more operations in FIG. 3 and FIG. 4, etc.), may be implemented in one or more systems, devices, or hardware components, such as one or more servers, and the like. In the following, descriptions of a device in which the systems or components of the example embodiments may be implemented are provided. It is contemplated that one or more operations or methods described above with reference to FIG. 3 to FIG. 4 may be performed by the device. For instance, the one or more operations or methods may be performed by at least one processor of the device upon executing machine-readable instructions or computer-readable instructions (e.g., instructions for implementing the Non-RT RIC, etc.) stored in a memory or a storage component of the device.

FIG. 7 illustrates an embodiment of a device 700 for implementing one or more example embodiments. As shown in FIG. 7, the device 700 includes a processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 causes the processor 710 to perform one or more method steps of an embodiment described herein.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, an instruction device to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of device 700 in communication with one another.

Further, according to example embodiments, the device 700 may include one or more elements from the system architecture described above in relation to FIG. 2. For example, the device 700 may include the RIC.

In the present disclosure, specific tasks may be performed using AI/ML (Artificial Intelligence/Machine Learning) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

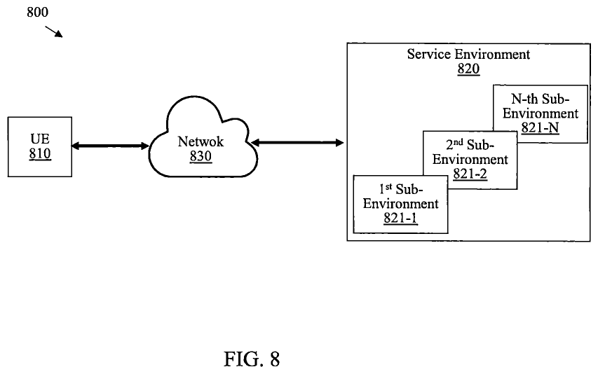

FIG. 8 is a diagram of an example of implementation environment 800 in which systems and/or method, described herein, may be implemented. The implementation environment 800 includes a UE (User equipment) 810, a service environment 820, and a network 830. The service environment 820 include one or more sub-environments 821. To illustrate this, FIG. 8 shows, for convenience, examples of a 1st sub-environment 821-1, a 2nd sub-environment 821-2, and an N-th sub-environment 821-N (where N is any natural number).

The UE 810 is connected to the network 830, and the network 830 is connected to the service environment 820. The connections may be wired, wireless, or a combination of both wired and wireless. The UE 810 and the service environment 820 are connected via the network 830.

The UE 810 is a device that communicates with the service environment 820. The UE 810 receives information from the service environment 820 and/or sends information to the service environment 820. Also, the UE 810 may generate and/or store information to be transmitted, as necessary. Also, the UE 810 may store and/or process information that is received, as necessary.

The example FIG. 8 refers to the “UE”. However, it should be understood by those skilled in the art that general terms such as “user device,” “terminal,” “terminal device,” “communication device,” and “communication terminal” can be used interchangeably with the term “UE.”

For example, the UE 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 820 is an environment that communicates with the UE 810 to provide one or more services. The service environment 820 receives information from the UE 810 and/or sends information to the UE 810. Also, the service environment 820 may generate and/or store information to be transmitted, as necessary. Also, the service environment 820 may store and/or process information that is received, as necessary. For example, the service environment 820 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 8 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 820 is not specifically limited and can be adjusted according to the embodiments. For example, the services may include a service that provides information to the UE 810, a service that stores information from the UE 810, or a service that performs processing based on information from the UE 810 and returns the results of the processing.

In an embodiment, the Service Environments 820 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 820 includes one or more devices, such as servers and network devices, which provide services or perform processes. The placement of these devices within the service environment 820 can be determined as appropriate. Additionally, if the service environment 820 includes one or more sub-environments 821, the placement of devices can be determined based on predetermined policies for each sub-environment 821. For example, devices related to the first service may be placed in the 1st sub-environment 821-1, and devices related to the second service may be placed in the 2nd sub-environment 821-2. In another example, devices expected to have a higher load than a predetermined threshold may be placed in the 1st sub-environment 821-1, while devices expected to have a lower load than the predetermined threshold may be placed in the 2nd sub-environment 821-2. In this way, specific devices can be placed in specific sub-environments 821. Conversely, each sub-environment 821 can be specialized for a particular purpose.

In an embodiment, all processes executed in a single service may run within a single service environment, or in multiple service environments. Multiple processes executed in a single service could be provided by different service environments.

The network 830 is a network that exchanges information between the UE 810 and the service environment 820. The network 830 includes one or more wired and/or wireless networks.

For example, the network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 830 can be a part of a network. For example, in a 5G network that includes a RAN, a transport network, and a core network, the network 830 can be at least one of the RAN, the transport network, or the core network. For example, the service environment 820 could be in the core network, in which case the network 830 could correspond to a network that is a combination of a RAN and a transport network and is part of the 5G network.

The number and arrangement of devices and networks shown in FIG. 8 are provided as an example. It should be understood that any changes that may be implemented by those skilled in the art, such as the addition or rearrangement of well-known devices or networks at the time of implementation, are included in this disclosure.

Various further respective aspects and features of embodiments of the present disclosure may be defined by the following items:
Item [1]: A system that may comprise a RAN Intelligence Controller (RIC) that may be configured to: obtain, from a first base station, Transfer Network Layer (TNL) information of the first base station; store the TNL information of the first base station in a database; receive, from a second base station, a request for the TNL information of the first base station; retrieve the TNL information specified in the request from the database; and transmit the retrieved TNL information to the second base station.
Item [2]: The system according to item [1], wherein the RIC may be configured to obtain the TNL information of the first base station by: transmitting a request to receive the TNL information of the first base station to the first base station; and receiving the TNL information of the first base station from the first base station.
Item [3]: The system according to item [2], wherein the RIC may be configured to transmit the request to receive the TNL information of the first base station to the first base station in response to completion of an E2 link setup with the first base station.
Item [4]: The system according to one of items [1]-[3], wherein the RIC may be configured to obtain the TNL information of the first base station by: establishing a subscription with the first base station to receive updated TNL information of the first base station; and receiving the updated TNL information of the first base station from the first base station.
Item [5]: The system according to one of items [1]-[4], wherein the request for the TNL information of the first base station may include a RIC indication message received via a RIC report service.
Item [6]: The system according to item [5], wherein the RIC indication message may include a New Radio Cell Global Identity (NR CGI) specifying an identifier of the first base station.
Item [7]: The system according to one of items [1]-[6], wherein the retrieved TNL information may be transmitted to the second base station via RIC Control Service Style 1.
Item [8]: A method that may include: obtaining, by a RAN Intelligence Controller (RIC) from a first base station, Transfer Network Layer (TNL) information of the first base station; storing, by the RIC, the TNL information of the first base station in a database; receiving, by the RIC from a second base station, a request for the TNL information of the first base station; retrieving, by the RIC, the TNL information specified in the request from the database; and transmitting, by the RIC, the retrieved TNL information to the second base station.
Item [9]: The method according to item [8], wherein the obtaining the TNL information of the first base station may include: transmitting a request to receive the TNL information of the first base station to the first base station; and receiving the TNL information of the first base station from the first base station.
Item [10]: The method according to item [9], wherein the request to receive the TNL information of the first base station may be transmitted to the first base station in response to completion of an E2 link setup with the first base station.
Item [11]: The method according to one of items [8]-[10], wherein the obtaining the TNL information of the first base station may include: establishing a subscription with the first base station to receive updated TNL information of the first base station; and receiving the updated TNL information of the first base station from the first base station.
Item [12]: The method according to one of items [8]-[11], wherein the request for the TNL information of the first base station may include a RIC indication message received via a RIC report service.
Item [13]: The method according to item [12], wherein the RIC indication message may include a New Radio Cell Global Identity (NR CGI) specifying an identifier of the first base station.
Item [14]: The method according to one of items [8]-[13], wherein the retrieved TNL information may be transmitted to the second base station via RIC Control Service Style 1.
Item [15]: A non-transitory computer-readable recording medium that may have recorded thereon instructions executable by a system that may include a RAN Intelligence Controller (RIC) to cause the RIC to perform a method including: obtaining, from a first base station, Transfer Network Layer (TNL) information of the first base station; storing the TNL information of the first base station in a database; receiving, from a second base station, a request for the TNL information of the first base station; retrieving the TNL information specified in the request from the database; and transmitting the retrieved TNL information to the second base station.
Item [16]: The non-transitory computer-readable recording medium according to item [15], wherein the obtaining the TNL information of the first base station may include: transmitting a request to receive the TNL information of the first base station to the first base station; and receiving the TNL information of the first base station from the first base station.

Item [17]: The non-transitory computer-readable recording medium according to item [16], wherein the request to receive the TNL information of the first base station may be transmitted to the first base station in response to completion of an E2 link setup with the first base station.
Item [18]: The non-transitory computer-readable recording medium according to one of items [15]-[17], wherein the obtaining the TNL information of the first base station may include: establishing a subscription with the first base station to receive updated TNL information of the first base station; and receiving the updated TNL information of the first base station from the first base station.
Item [19]: The non-transitory computer-readable recording medium according to one of items [15]-[18], wherein the request for the TNL information of the first base station may include a RIC indication message received via a RIC report service.
Item [20]: The non-transitory computer-readable recording medium according to item [19], wherein the RIC indication message may include a New Radio Cell Global Identity (NR CGI) specifying an identifier of the first base station.

It is understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a RAN Intelligence Controller (RIC) configured to:
obtain, from a first base station, Transfer Network Layer (TNL) information of the first base station;
store the TNL information of the first base station in a database;
receive, from a second base station, a request for the TNL information of the first base station;
retrieve the TNL information specified in the request from the database; and
transmit the retrieved TNL information to the second base station.

2. The system according to claim 1, wherein the RIC is configured to obtain the TNL information of the first base station by: transmitting a request to receive the TNL information of the first base station to the first base station; and receiving the TNL information of the first base station from the first base station.

3. The system according to claim 2, wherein the RIC is configured to transmit the request to receive the TNL information of the first base station to the first base station in response to completion of an E2 link setup with the first base station.

4. The system according to claim 1, wherein the RIC is configured to obtain the TNL information of the first base station by: establishing a subscription with the first base station to receive updated TNL information of the first base station; and receiving the updated TNL information of the first base station from the first base station.

5. The system according to claim 1, wherein the request for the TNL information of the first base station comprises a RIC indication message received via a RIC report service.

6. The system according to claim 5, wherein the RIC indication message comprises a New Radio Cell Global Identity (NR CGI) specifying an identifier of the first base station.

7. The system according to claim 1, wherein the retrieved TNL information is transmitted to the second base station via RIC Control Service Style 1.

8. A method comprising:
obtaining, by a RAN Intelligence Controller (RIC) from a first base station, Transfer Network Layer (TNL) information of the first base station;
storing, by the RIC, the TNL information of the first base station in a database;
receiving, by the RIC from a second base station, a request for the TNL information of the first base station;
retrieving, by the RIC, the TNL information specified in the request from the database; and
transmitting, by the RIC, the retrieved TNL information to the second base station.

9. The method according to claim 8, wherein the obtaining the TNL information of the first base station comprises: transmitting a request to receive the TNL information of the first base station to the first base station; and receiving the TNL information of the first base station from the first base station.

10. The method according to claim 9, wherein the request to receive the TNL information of the first base station is transmitted to the first base station in response to completion of an E2 link setup with the first base station.

11. The method according to claim 8, wherein the obtaining the TNL information of the first base station comprises: establishing a subscription with the first base station to receive updated TNL information of the first base station; and receiving the updated TNL information of the first base station from the first base station.

12. The method according to claim 8, wherein the request for the TNL information of the first base station comprises a RIC indication message received via a RIC report service.

13. The method according to claim 12, wherein the RIC indication message comprises a New Radio Cell Global Identity (NR CGI) specifying an identifier of the first base station.

14. The method according to claim 8, wherein the retrieved TNL information is transmitted to the second base station via RIC Control Service Style 1.

15. A non-transitory computer-readable recording medium having recorded thereon instructions executable by a system comprising a RAN Intelligence Controller (RIC) to cause the RIC to perform a method comprising:
obtaining, from a first base station, Transfer Network Layer (TNL) information of the first base station;
storing the TNL information of the first base station in a database;
receiving, from a second base station, a request for the TNL information of the first base station;
retrieving the TNL information specified in the request from the database; and
transmitting the retrieved TNL information to the second base station.

16. The non-transitory computer-readable recording medium according to claim 15, wherein the obtaining the TNL information of the first base station comprises: transmitting a request to receive the TNL information of the first base station to the first base station; and receiving the TNL information of the first base station from the first base station.

17. The non-transitory computer-readable recording medium according to claim 16, wherein the request to receive the TNL information of the first base station is transmitted to the first base station in response to completion of an E2 link setup with the first base station.

18. The non-transitory computer-readable recording medium according to claim 15, wherein the obtaining the TNL information of the first base station comprises: establishing a subscription with the first base station to receive updated TNL information of the first base station; and receiving the updated TNL information of the first base station from the first base station.

19. The non-transitory computer-readable recording medium according to claim 15, wherein the request for the TNL information of the first base station comprises a RIC indication message received via a RIC report service.

20. The non-transitory computer-readable recording medium according to claim 19, wherein the RIC indication message comprises a New Radio Cell Global Identity (NR CGI) specifying an identifier of the first base station.
